(19) United States
(12) Patent Application Publication
(10) Pub. No.: US 2024/0311038 A1
(43) Pub. Date: Sep. 19, 2024

(54) SYSTEM AND METHOD FOR PATH-BASED IN-MEMORY COMPUTING

(71) Applicants: University of Central Florida Research Foundation, Inc., Orlando, FL (US); Board of Regents, University of Texas System, Austin, TX (US)

(72) Inventors: Rickard Ewetz, Orlando, FL (US); Sven Thijssen, Orlando, FL (US); Sumit Kumar Jha, Miami, FL (US)

(21) Appl. No.: 18/406,997

(22) Filed: Jan. 8, 2024

Related U.S. Application Data
(60) Provisional application No. 63/450,112, filed on Mar. 6, 2023.

(51) Int. Cl. G06F 3/06

(52) U.S. Cl. CPC G06F 3/0655; G06F 3/0604; G06F 3/0653; G06F 3/0679

(57) ABSTRACT

A system and method for evaluating Boolean functions using in-memory computing comprising a plurality of programmed non-volatile memory devices synthesized in a crossbar design. The evaluation phase of a given Boolean function using the programmed non-volatile memory devices is accomplished using READ operations only.

### CROSS-REFERENCE TO RELATED APPLICATIONS

This application claims priority to currently pending U.S. Provisional Patent Application No. 63/450,112, filed on Mar. 6, 2023, the entire contents of which is hereby incorporated herein by reference.

### FEDERALLY SPONSORED RESEARCH OR DEVELOPMENT

This invention was made with Government support under National Science Foundation Award No.: 1822976. The government has certain rights in the invention.

### BACKGROUND OF THE INVENTION

The growth of digital data accelerates at a high pace. In 2025, the total amount of digital data is expected to be 175ZB. This growth is driven by a variety of factors, one being the collection of sensor data using IoT (Internet of Things) devices. The development of 5G and 6G networks will only accelerate the amassment of this data further. Another contributing factor is the emergence of data-driven technologies, such as deep neural networks, and foundational AI models, which require internet-scale amounts of digital data for unsupervised pre-training. Unfortunately, these data-intensive techniques suffer from the Von Neumann bottleneck. The bottleneck denotes the energy-inefficiency of a bus to transfer data between a computer's memory and computing units. Several other factors, such as the End of Moore's Law and the End of Dennard Scaling are challenging the performance of these data-intensive applications.

Processing in-memory using non-volatile memory has recently attracted significant attention to mitigate the aforementioned limitations. Non-volatile memory technology includes memristor, resistive random access memory (ReRAM), phase change memory (PCM), and spin-transfer torque magnetic random access memory (STT-MRAM). Analog in-memory computing is well-known for performing matrix-vector multiplication at high-speed and with low energy consumption. These computations are carried out in dense crossbar arrays. Unfortunately, analog in-memory computing is limited to matrix-vector multiplication and related arithmetic operations. Some efforts have been made to improve accuracy while maintaining these energy and latency advantages. Unfortunately, despite these efforts, analog in-memory computing cannot deliver the deterministic precision required for high-assurance applications. However, digital computing is more robust due to the clear distinct states for a logical zero and one.

Several noteworthy digital in-memory computing paradigms known in the art include, IMPLY, MAGIC, MAJORITY and FLOW. These in-memory computing paradigms more or less have the following in common: the paradigms consist of two broad phases. First, there is a one-time compilation phase and, second, an execution phase that is performed for each function input. Table I illustrates the READ and WRITE operations performed in each phase for the different logic styles. It can be observed that all previous paradigms use WRITE operations in the execution phase. WRITE operations are orders of magnitude more expensive than READ operations. Further, WRITE operations are detrimental to the endurance of the memristor's lifetime. In contrast, the proposed path-based computing paradigm evaluates Boolean logic using READ operations in the execution phase, mitigating the high energy consumption for the WRITE operations and thus extending the system's lifetime.

TABLE I
Comparison of In-Memory Logic Styles in Terms of Underlying
Operation and Evaluated Logic Complexity.

Operations in Each Phase

| Digital Logic Style | Compile | Execute |
|---|---|---|
| IMPLY | WRITE | WRITE + READ |
| MAGIC | WRITE | WRITE + READ |
| MAJORITY | WRITE | WRITE + READ |
| FLOW | WRITE | WRITE + READ |
| Path-based (Invention) | WRITE | READ |

Further, design automation tools are essential to map computation into hardware designs. Hardware-software co-design is a trending approach in a variety of novel computing schemes, including photonic computing, quantum computing, and in-memory computing to optimize the hardware resources.

Accordingly, what is needed in the art is an improved system and method for path-based in-memory computing.

### SUMMARY OF INVENTION

In various embodiments, the present invention provides a path-based paradigm for evaluating Boolean logic using inexpensive READ operations in the execution phase.

In-memory computing using non-volatile memory is a promising pathway to accelerate data-intensive applications. While substantial research efforts have been dedicated to executing Boolean logic using digital in-memory computing, the limitation of state-of-the-art paradigms is that they heavily rely on repeatedly switching the state of the non-volatile resistive devices using expensive WRITE operations.

In the embodiments of the present invention, a new in-memory computing paradigm called is proposed for path-based computing for evaluating Boolean logic. Computation within the paradigm is performed using a one-time expensive compilation phase and a fast and efficient evaluation phase. The key property of the paradigm is that the execution phase only involves cheap READ operations. First, an analogy between binary decision diagrams (BDDs) and one-transistor one-memristor (1T1M) crossbars that allows Boolean functions to be mapped into crossbar designs is defined. When such crossbar design becomes too large to be physically realizable, the Boolean function is synthesized into a path-based computing system. A path-based computing system consists of a topology of staircase structures. A staircase structure is a cascade of hardwired crossbars, which minimizes inter-crossbar communication.

In one embodiment, the present invention provides a method for evaluating Boolean functions using in-memory computing. The method includes, receiving one or more Boolean functions as input to a compilation phase and synthesizing a crossbar design during the compilation phase for the one or more Boolean functions, wherein the crossbar design comprises a plurality of non-volatile memory devices. The method further includes programming each of the plurality of non-volatile memory devices in the crossbar design to a resistive state and performing an evaluation phase for a given Boolean function with the programmed non-volatile memory devices, wherein the evaluation phase comprises only READ operations.

An analogy between binary decision diagrams corresponding to the one or more Boolean functions and a one-transistor one-memristor (1T1M) crossbar design is used to map the one or more Boolean functions to the crossbar design. The 1T1M crossbar design comprises a plurality of wordlines, a plurality of bitlines and a plurality of selectorlines, wherein each of the plurality of wordlines is connected to each of the plurality of bitlines using a series-connected memristor and access transistor and wherein vertically aligned access transistors share a single selectorline of the plurality of selectorlines.

In a specific embodiment, the crossbar design further comprises a topology of staircase structures in the crossbar design, wherein the topology of staircase structures is an ordered set of crossbars in the crossbar design having hardwired intra-connections and inter-connections.

In another embodiment, the present invention provides a system for evaluating Boolean functions using in-memory computing. The system includes a plurality of non-volatile memory devices synthesized into a cross bar design and WRITE circuitry coupled to the plurality of non-volatile memory devices, wherein the plurality of non-volatile memory devices are programmed by the WRITE circuitry to a resistive state during a compilation phase based upon one or more Boolean functions. The system further includes READ circuitry coupled to the plurality of non-volatile memory devices, wherein the READ circuitry performs only READ operations on the plurality of non-volatile memory devices during an evaluation phase to evaluate a given Boolean function.

In an additional embodiment, the present invention provides a non-transitory computer-readable medium, the computer-readable medium having computer-readable instructions stored thereon for performing the method of the present invention.

It has been shown that, compared with state-of-the-art digital in-memory computing paradigms, the path-based computing of the present invention improves energy and latency with 1006× and 10× on average, respectively.

### BRIEF DESCRIPTION OF THE DRAWINGS

For a fuller understanding of the invention, reference should be made to the following detailed description, taken in connection with the accompanying drawings, in which:

FIG. 1A illustrates a traditional bus architecture, as is known in the prior art.

FIG. 1B illustrates and a staircase architecture, wherein each staircase is a collection or hardwired crossbars, in accordance with an embodiment of the present invention.

FIG. 2A illustrates a program in Verilog implemented in a flow for evaluating Boolean functions using path-based computing, in accordance with an embodiment of the present invention.

FIG. 2B illustrates the abstract crossbar design obtained through synthesis when implemented in a flow for evaluating Boolean functions using path-based computing, in accordance with an embodiment of the present invention.

FIG. 2C illustrates the physical crossbar with the non-volatile memory devices programmed and Boolean variables assigned to the selectorlines when implemented in a flow for evaluating Boolean functions using path-based computing, in accordance with an embodiment of the present invention.

FIG. 2D illustrates the state of the switches (open/closed) with respect to the state of the nonvolatile memory devices (on/off) and the instance (a,b,c)=(1,1,0) of the Boolean variables when implemented in a flow for evaluating Boolean functions using path-based computing, in accordance with an embodiment of the present invention.

FIG. 2E illustrates the Boolean function ƒ evaluates to 1 because there is a path from the input to the output, when implemented in a flow for evaluating Boolean functions using path-based computing, in accordance with an embodiment of the present invention.

FIG. 3 illustrates an execution of all four input vectors on a crossbar for the Boolean function ƒ=a V¬b, wherein the state of the memristors does not change for different input vectors, but only the state of the access transistors changes using the selectorlines, in accordance with an embodiment of the present invention.

FIG. 4A illustrates the last step of the compilation phase and the steps during the execution phase for digital in-memory logic style IMPLY.

FIG. 4B illustrates the last step of the compilation phase and the steps during the execution phase for digital in-memory logic style MAGIC.

FIG. 4C illustrates the last step of the compilation phase and the steps during the execution phase for digital in-memory logic style MAJORITY.

FIG. 4D illustrates the last step of the compilation phase and the steps during the execution phase for digital in-memory logic style FLOW.

FIG. 4E illustrates the last step of the compilation phase and the steps during the execution phase for digital in-memory logic style PATH, in accordance with an embodiment of the present invention.

FIG. 5 is a flow diagram illustrating an overview of the PATH framework, including the crossbar synthesis and staircase partitioning, in accordance with an embodiment of the present invention.

FIG. 6A illustrates a multi-output BDD for a full adder with Boolean functions cₒᵤₜ and so, in accordance with an embodiment of the present invention.

FIG. 6B illustrates that the nodes of the BDD are relabeled and the edges are assigned a Boolean literal based on their shape (positive literal for solid edges and negative literal for dashed edges), and the negative terminal node 0 is removed, in accordance with an embodiment of the present invention.

FIG. 6C illustrates the bipartite graph B=(U₁, U₂, F) that is constructed from the pruned graph G, in accordance with an embodiment of the present invention.

FIG. 6D illustrates the bipartite graph B that is compressed into an equivalent bipartite graph B′=(U′₁, U′₂, F′) using node merging, in accordance with an embodiment of the present invention.

FIG. 6E illustrates a crossbar design [symbol] that is constructed with dimensions |U′₁|×|U′₂| where each node u₁∈U′₁ is assigned to a wordline and each node u₂∈U′₂ is assigned to a bitline-selectorline pair, in accordance with an embodiment of the present invention.

FIG. 7A illustrates a compressed bipartite graph B′, in accordance with a high-level overview of the partitioning scheme of the present invention.

FIG. 7B illustrates partitioned bipartite subgraphs, wherein the input of the partitioning scheme is the compressed bipartite graph B′ and the user-defined parameter T=2, in accordance with a high-level overview of the partitioning scheme of the present invention.

FIG. 7C illustrates the synthesis of the individual subgraphs into crossbar designs, in accordance with a high-level overview of the partitioning scheme of the present invention.

FIG. 7D illustrates the construction of a staircase topology by realizing intra-staircase and inter-staircase connections, in accordance with a high-level overview of the partitioning scheme of the present invention.

FIG. 8A illustrates an example of the intra-connections during edge preparation, in accordance with an embodiment of the present invention.

FIG. 8B illustrates an example of the intra-connections during node propagation, in accordance with an embodiment of the present invention.

FIG. 8C illustrates an example of the intra-connections during literal propagation, in accordance with an embodiment of the present invention.

FIG. 9A illustrates that a bank consists of multiple tiles T, in accordance with a high-level overview of the architecture of an embodiment of the present invention.

FIG. 9B illustrates each tile T contains multiple staircases S and the topology of the staircases is according to a H-Tree, in accordance with a high-level overview of the architecture of an embodiment of the present invention.

FIG. 9C illustrates that each staircase S contains a series of crossbars X, in accordance with a high-level overview of the architecture of an embodiment of the present invention.

FIG. 10 is a graphical illustration of the number of staircases in terms of BDD size for eight ISCAS85 benchmarks.

FIG. 11A is a graphical illustration of the number of staircases for the EPFL benchmark arbiter for varying dimensions, in accordance with the present invention.

FIG. 11B is a graphical illustration of the number of inter-connections for the EPFL benchmark arbiter for varying dimensions, in accordance with the present invention.

FIG. 12 is a graphical illustration of the percentage for each of the components in a staircase topology using the PATH framework, wherein the components include logic, node propagation, edge preparation and literal propagation and wherein the percentages are the averages over the ten Revlib, eight EPFL benchmarks, and eight ISCAS85 benchmarks.

FIG. 13A is a graphical illustration of the normalized energy consumption for PATH, COMPACT, ArC, and CONTRA for ten Revlib benchmarks, eight EPFL benchmarks, and eight ISCAS85 benchmarks.

FIG. 13B is a graphical illustration of the latency for PATH, COMPACT, ArC, and CONTRA for ten Revlib benchmarks, eight EPFL benchmarks, and eight ISCAS85 benchmarks.

FIG. 13C is a graphical illustration of the area for PATH, COMPACT, ArC, and CONTRA for ten Revlib benchmarks, eight EPFL benchmarks, and eight ISCAS85 benchmarks.

### DETAILED DESCRIPTION OF THE INVENTION

In various embodiments, the present invention provides an improved system and method for evaluating Boolean login using path-based in-memory computing. The system and method of the present invention is capable of evaluating Boolean functions using 1T1M crossbar arrays utilizing a framework called PATH to automatically map computation to 1T1M crossbars or path-based computing systems with staircase structures.

In the present invention a tight hardware/software co-design proposed for 1T1M crossbars and Boolean functions. To achieve this strong relation between hardware and software, an analogy between binary decision diagrams (BDDs) and one-transistor one-memristor (1T1M) crossbars is established.

A binary decision diagram (BDD) is a graph representation of a Boolean function. The directed acyclic graph (DAG) consists of internal decision nodes and two leaf (terminal) nodes. The terminal nodes represent the output ‘0’ and ‘1’, respectively. The internal decision nodes are assigned a Boolean variable, and each internal decision node has a positive and negative output edge. The positive edge corresponds to the positive literal, and the negative edge corresponds to the negative literal. A BDD is evaluated by traversing the graph from the root nodes to one of the leaf nodes based on an instance of the Boolean variables. BDDs commonly refer to reduced order binary decision diagrams (ROBDDs) where nodes and edge have been eliminated to reduce the size of the representation. When a BDD is used to represent a multi-output function, the BDD will have a separate root node for each output of the Boolean function.

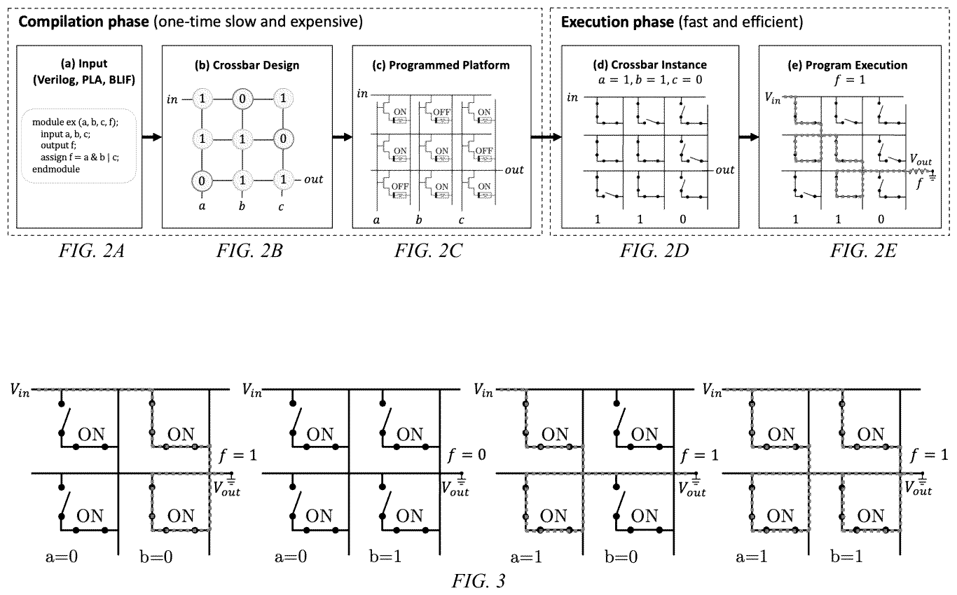

A model for a 1T1M crossbar is illustrated in FIG. 2C. A 1T1M crossbar array consists of wordlines, bitlines, and selectorlines. Each wordline is connected to each bitline using a series-connected memristor and access transistor. The vertically aligned access transistors share a single selectorline. Both the memristors and the access transistors act functionally as switches that can be turned ON and OFF. The switch corresponding to a memristor is ON (or OFF) based on if the memristor is programmed to have low (or high) resistance. The switch corresponding to the access transistor is turned ON (or OFF) based on if the selector line is charged (or discharged, depending on the type of transistor).

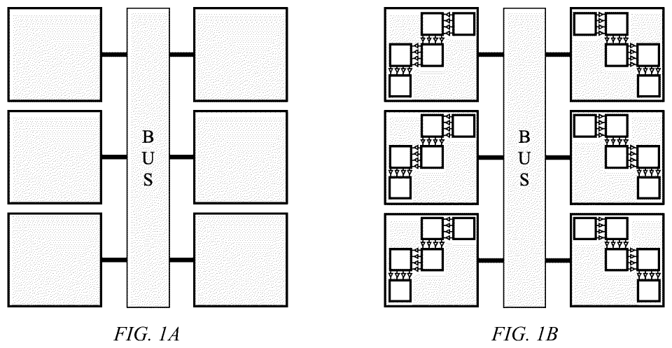

Traditionally, bus architectures have been leveraged for in-memory computing. In this computing architecture, the crossbars are connected to a bus. An example of a bus architecture with six crossbars is illustrated in FIG. 1A. However, in the present invention, a path-based computing system with staircase structures is targeted. A staircase structure is a collection of crossbars that have hardwired inter-connections. FIG. 1B illustrates a staircase architecture of six staircases where each staircase consists of five hardwired crossbars.

Path-based computing aims to evaluate Boolean functions using in-memory computing. An example of the flow for the synthesis and evaluation of path-based computing is shown in FIG. 2. The flow for path-based computing consists of one-time slow and expensive compilation phase and a fast and efficient execution phase. The input to the compilation phase is a Boolean function specified in a hardware descriptive language (Verilog, VHDL), which is shown in FIG. 2A. The input is first synthesized into an abstract crossbar design [symbol] , which is shown in FIG. 2B. The 1T1M crossbar design specifies the state of each non-volatile memory device (0/1) and the Boolean variable assigned to each selectorline. Here, the Boolean literals a, b, and c are assigned to the first, second, and third selectorline, respectively. The input and output assignment to the wordlines are also specified. Next, the memory devices within a nanoscale crossbar are programmed ON (LRS) or OFF (HRS), which is shown in FIG. 2C. The state of the devices is programmed to LRS or HRS by applying a voltage with appropriate polarity and magnitude. A write-and-verify scheme is used to ensure the correct programming.

In the execution phase, an instance of Boolean variables is provided to the selectorlines. The selectorlines control the switches represented by the access transistors. The state of the switches controlled by the memory devices are also shown in FIG. 2D. Next, an input voltage is applied to the top-most wordline and an output voltage is measured across a resistor connected to the bottom-most wordline. If the output voltage is high, the Boolean function evaluates to true. Otherwise, the function evaluates to false. For the input instance (a,b,c)=(1,1,0), the function evaluates to true because there exists a path from the input to the output, as illustrated in FIG. 2E. In contrast, the function evaluates to false for the input instance (1,0,0). Observe that the memristors must not be reprogrammed to evaluate the same Boolean function for different input vectors. In FIG. 3, a more detailed example is shown for the Boolean function ƒ=a V¬b. More specifically, the state of the crossbar is shown for all four input vectors. Again, the crossbar must not be reprogrammed for different input vectors.

The one-time compilation phase is both slow and expensive. Mainly, due to the expensive WRITE operations used to program the platform. On the other hand, the cost is amortized across each execution of the Boolean function. The execution phase is fast and efficient because it only involves charging/decharging the selectorlines and performing READ operations. The advantageous properties compared with other in-memory paradigms comes from the novel use of the access transistors. No previous paradigms have used the access transistors to perform logic.

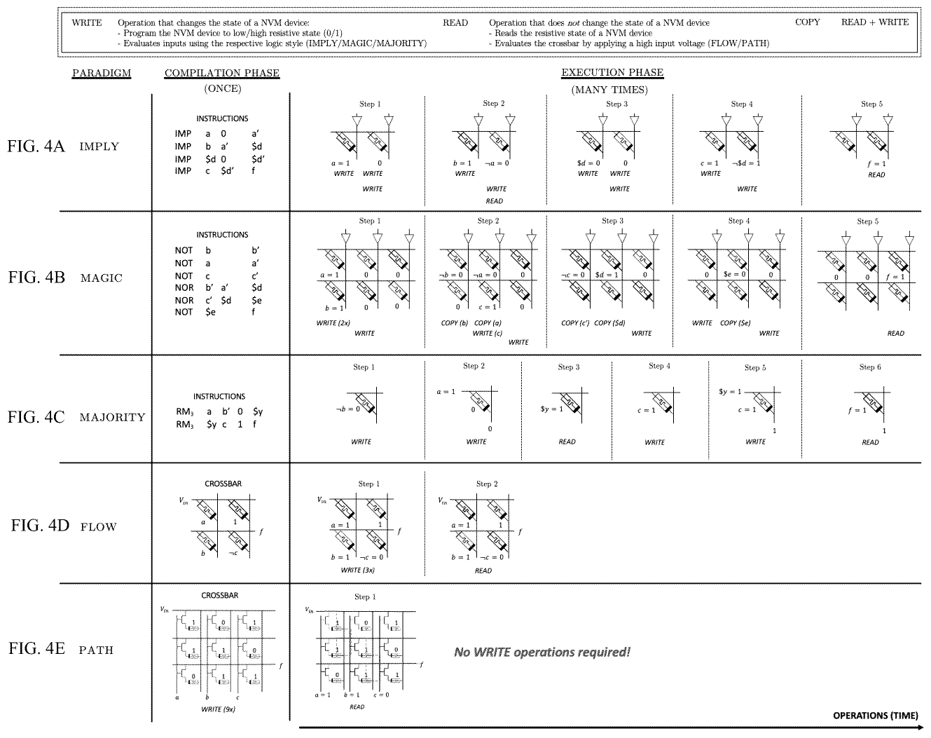

Digital in-memory computing paradigms are known in the art. Some of the most prevalent state-of-the art paradigms are now compared to the proposed path-based in-memory computing paradigm (PATH) of the present invention. The known digital in-memory computing paradigms include IMPLY, MAGIC, MAJORITY and FLOW. FIG. 4A-FIG. 4E illustrate the steps during execution for each of the logic styles to evaluate the Boolean function ƒ=(a∧b) V¬c for the input vector a=1, b=1, c=1. For consistency, the following basic operations amount these logic styles are employed: READ, WRITE and COPY (READ+WRITE). The definitions are provided in the legend at the top of FIG. 4A-FIG. 4E.

IMPLY logic is based on the Boolean operation material implication (IMP). The IMP operation P→ [symbol] can be realized in hardware using two memristors P and [symbol] . By applying voltages over the memristors P and [symbol] , the result is obtained in the memristor [symbol] . Thus, IMPLY logic is destructive in terms of its inputs. Further, extensive design automation tools for IMPLY-based in-memory computing have not been developed, usually requiring manual labor to design circuits. In FIG. 4A, it can be observed that IMPLY requires many intermediate steps of READ and WRITE operations to realize the Boolean function ƒ. The required IMP operations are also provided in FIG. 4A.

The MAGIC logic style is based on the Boolean operation NOR and can be considered the successor of IMPLY. The NOR operation can be realized using three memristors. The NOT operation is a NOR operation where one input is always ‘1’. In contrast with IMPLY, MAGIC is not destructive for its inputs when applying the appropriate voltage. Further, there is an additional memristor for the output to be realized. In FIG. 4B, it is shown that the steps to realize the Boolean function ƒ using READ, WRITE, and COPY operations.

The MAJORITY operation is a Boolean function that evaluates to true when half or more of its inputs evaluate true. For in-memory computing, the MAJORITY operation with three inputs is primarily interesting due to its one-to-one correspondence with a single memristor. The MAJORITY operation is defined as Z′=M(X,¬Y,Z)=(X∧Z)∨(¬Y∧Z)∨(X∧¬Y). Then let X and Y be the inputs to the two terminals of the memristor, and let Z be the resistive state of the memristor. By applying the appropriate voltages to the inputs and programming the memristor to the appropriate resistive state, the majority function can be executed in-situ. The resulting value Z′ is then stored as a resistive value in the memristor. Several synthesis methods have been proposed in recent years, many of which rely on majority inverter graphs (MIGs) as data structure. FIG. 4C illustrates the steps using READ and WRITE operations for the MAJORITYogic style.

FLOW (flow-based computing) is a digital in-memory computing paradigm which relies on the absence/presence of electrical current to perform its computations. Initially, the input variables, their negations, and the Boolean truth values (0/1) are assigned to the memristors. Program execution consists of two steps. In the first step, the memristors are programmed to their resistive states (0 for high, 1 for low), as shown in the first step of FIG. 4D. In the second step, a high input voltage is applied to the input wordline (Vin) and the Boolean function is read out as follows: if there is a path from the input wordline to the output wordline through memristors in a low resistive state, then the Boolean function evaluates to true. Otherwise, the Boolean function evaluates to false.

In the proposed path-based computing (PATH) of the present invention, the program execution solely relies on READ operations, and the application of an input voltage to perform computations. WRITE operations are only performed once during the previous step, i.e., the compilation phase, for a given Boolean function. In the first step of FIG. 4E, the crossbar design is shown. The memristors are in their resistive states, which were programmed only once prior, during 1T1M crossbar reconfiguration, as previously described. During program execution there are no WRITE operations, and thus these resistive states do not change. However, the selectorlines are charged accordingly to open/close access transistors. The memristors are programmed to their resistive states only once for a given Boolean function. Given another input vector a=0, b=1, c=0, the crossbar design in FIG. 4E, would remain, and is thus invariant to the input vector. Then, in the second step, the evaluation is read out by sensing the presence/absence of electrical current. The crossbar invariancy makes PATH a strong contender for repeated computations.

In accordance with the present invention, the overall objective is to synthesize a Boolean function ϕ into a path-based computing system. This larger problem is approached by solving two smaller problems, as follows: Problem I: A synthesis method to construct a crossbar design [symbol] for a Boolean function ϕ is proposed. The algorithm is based on an analogy between a BDD for the Boolean function ϕ and a 1T1M crossbar. It is further proposed to improve the synthesis method by transforming the BDD into an equivalent graph-based data structure such that one can reduce its graph size by merging nodes. This transformation results in smaller crossbar designs, and subsequently power and latency improvements. Problem II: Based on the analogy of Problem I, a synthesis method is proposed to construct a topology [symbol] for a path-based computing system of staircase structures Sⱼ. A staircase structure Sⱼ is an ordered set of crossbars Xᵢ. Between each Xᵢ and Xᵢ₊₁, there are hardwired inter-crossbar connections from the wordlines of crossbar Xᵢ to the selectorlines of crossbar Xᵢ₊₁.

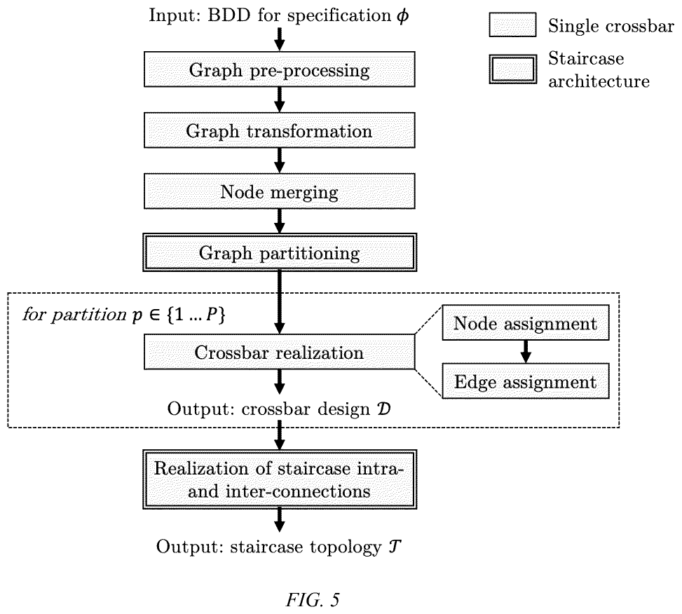

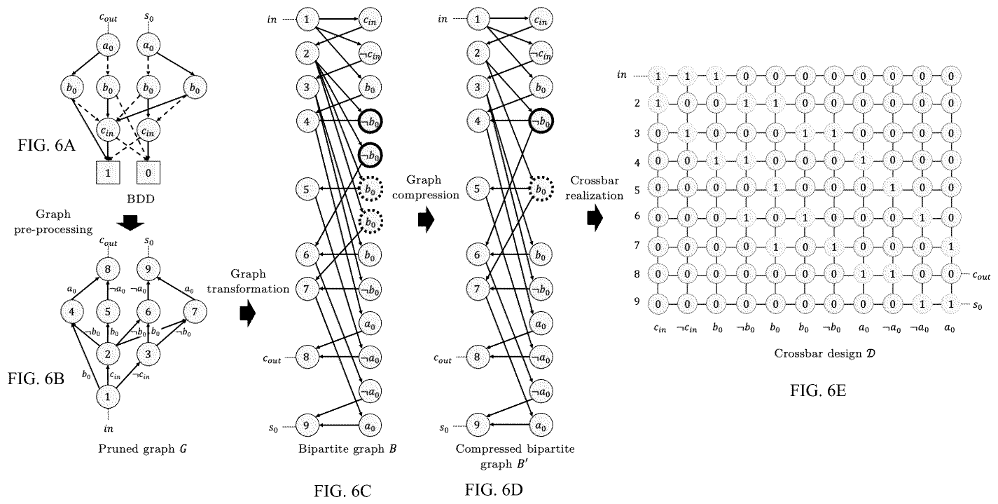

An overview of the synthesis flow of the PATH framework is shown in FIG. 5, including the crossbar synthesis and staircase partitioning. For the crossbar synthesis, an algorithm is introduced to construct a single crossbar design [symbol] based on an analogy between a bipartite graph, derived from a BDD for the Boolean function(s), and a 1T1M crossbar. This algorithm consists of four steps: graph pre-processing, graph transformation, node merging, and crossbar realization. A partitioning algorithm is also introduced. The main steps for the partitioning are the graph partitioning, and the realization of staircase intra- and inter-connections. The framework is illustrated in FIG. 6A-FIG. 6E.

The input to the framework is a BDD, and the output is a crossbar design. The BDD is obtained using Colorado University Decision Diagram (CUDD) which is subsequently pruned into a graph G. The input to the graph pre-processing step is a BDD. In FIG. 6A, a multi-output BDD for a full adder is provided. The Boolean functions are cₒᵤₜ=(a₀∧b₀)∨(a₀∧cᵢₙ)∨(b₀∧cᵢₙ) and s₀=a₀⊕b₀⊕cᵢₙ, respectively. The graph pre-processing involves removing the zero output node and all the edges connected to the zero terminal node. The zero terminal node can be removed because it corresponds to ¬cₒᵤₜ and ¬s₀. The one terminal node will be connected to the input, which is labeled in. The edges in the BDD are labeled with their respective decision variables. The positive (negative) edge connected to node with the decision variable xᵢ will be labeled xᵢ (¬xᵢ). Finally, the edges are reversed, and the nodes are labeled 1 to |V| where |V| is the number of nodes. The resulting graph of the BDD in FIG. 6A is shown in FIG. 6B.

In the graph transformation step, the resulting pruned graph is converted into a bidirected bipartite graph. This graph transformation is introduced as an intermediary data for the node merging step. Let G=(V, E) be the pruned graph where Vis a set of nodes and E is a set of edges, and let B=(U₁, U₂, F) be a bipartite graph where U₁ and U₂ are sets of nodes and F is a set of edges. The sets U₁ and U₂ are disjoint and independent, and F is a new set of edges between nodes from U₁ and U₂. Let v∈V correspond to a node u₁∈U₁ and let e∈E correspond to a node

$${u}_{1} {∈}_{1} {U}_{1}$$

u₂∈U₂. For each node₁ᵥ∈V, a node is introduced. For each edge in the BDD, a node with two edges is introduced. More specifically, for an edge e=(v₁, v₂, l)∈E where v₁∈V, v₂∈V and l is a literal, a new node u₂=(u₁¹, u₁², l)∈U₂ is created where u₁¹ is the image of v₁ and u₁² is the image of v₂. Then, the connections between nodes and edges are realized by introducing two new edges in F for each node u₂∈U₂ such that F={(u₁¹, u₂), (u₂, u₁²)|u₂=(u₁¹, u₁², l), u₂∈U₂}. An example of the transformation of the pruned graph G into a bipartite graph B is illustrated in FIG. 6C. Note that the nodes in U₂ and their literals l are represented instead of the triple (u₁¹, u₂², l) for clarity.

In the bipartite graph, it is observed that a node u₁∈U₁ may have outgoing edges to more than one node u₂∈U₂ with the same literal l. For example, in FIG. 6C, it is observed that node 2 in the bipartite graph B has two outgoing edges to two distinct nodes with both label ¬b. It is proposed to merge such nodes with the same label into a single node.

More formally, let B=(U₁, U₂, F) be the bipartite graph and let u₁∈U₁ be a node with outgoing edges to nodes u₂ⁱ=(u₁, uᵢ, l) and u₂^{j}=(u₁, uⱼ, l) where i≠j, and u₁, uᵢ, uⱼ∈U₁. Then a mapping B=(U₁, U₂, F)=>B′=(U′₁, U′₂, F′) is defined as follows:

$${U}_{1} \to {U}_{1}^{′} : {u}_{1} ↦ {u}_{1}$$

$${U}_{2} \to {U}_{2}^{′} : {u}_{2} = ( {u}_{1} , {u}_{i} , l ) ↦ {u}_{2}^{′} = ( {u}_{1} , l )$$

$$F \to {F}^{′} : f = ( {u}_{1} , ( {u}_{1} , {u}_{i} , l ) ) ↦ {f}^{′} = ( {u}_{1} , ( {u}_{1} , l ) ) and$$

$$f = ( ( {u}_{1} , {u}_{i} , l ) , {u}_{1} ) ↦ {f}^{′} = ( ( {u}_{1} , l ) , {u}_{1} )$$

Based on the aforementioned mapping function, one can merge the two nodes with label ¬b into one node such that a compressed bipartite graph B′ is obtained, as illustrated in FIG. 6D. This operation is valid because the nodes u₂∈U₂ represent literals l, and the edges between u₁∈U₁ and u₂∈U₂ represent conjunctions between u₁ and u₂. Thus, for two such edges (u₁, uᵢ) and (u₁, uⱼ), one has the following: u₁∧uᵢ=u₁∧l=u₁∧uⱼ.

The outlined crossbar realization is based on an analogy between the bipartite graph B′=(U′₁, U′₂, F′) and 1T1M crossbars. The nodes u₁∈U′₁ correspond to wordlines and the nodes u₂∈U′₂ correspond to bitline-selectorline pairs. The path-based paradigm is based on creating paths by turning on and off connections in the crossbar design. The connections correspond with the edges ƒ∈F′, which are realized using the bitline-selectorline pairs. The crossbar mapping consists of a node assignment step and an edge assignment step.

The node assignment involves assigning the nodes u₁∈U′₁ to the wordlines of the crossbar design [symbol] and the nodes u₂∈U′₂ to the bitline-selectorline pairs of the crossbar design [symbol] .

Next, for each edge ƒ=(u₁, u₂) or ƒ=(u₂, u₁), u₁∈U₁ and u₂∈U₂, ƒ∈F, the corresponding memristor at the intersection of wordline u₁ and selectorline u₂ is programmed to a low resistive state (ON). Further, the input and output are assigned to the respective wordlines. The resulting crossbar design [symbol] for the Boolean functions ƒ₁ and ƒ₂ is shown in FIG. 6E.

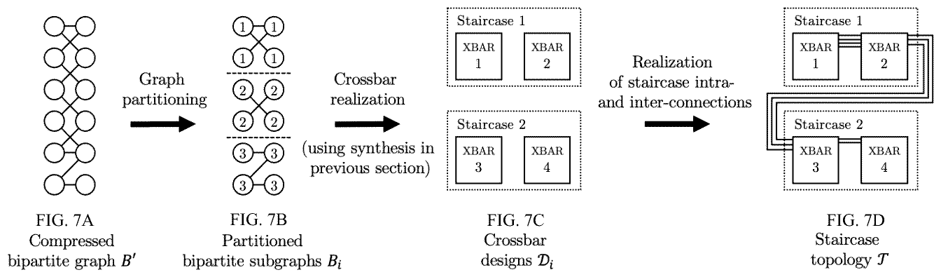

A partitioning algorithm is proposed to synthesize the Boolean function ϕ into a topology [symbol] of staircase structures. A topology is a directed acyclic graph (DAG) of staircase structures with potentially multiple edges between different staircase structures where each staircase structure is an ordered set of crossbars with inter-crossbar connections between two consecutive crossbars. An overview of the partitioning scheme is illustrated in FIG. 7A-FIG. 7D.

The input of the partitioning algorithm is a bipartite graph B=(U₁, U₂, F) and the output is a topology [symbol] of staircase structures. The bipartite graph B is obtained by means of the pre-processing steps, as previously described. The idea of the partitioning scheme is that the given bipartite graph B is partitioned into smaller bipartite graphs Bᵢ=(U_{1,i}, U_{2,i}, Fᵢ), |U_{1,i}+U_{2,i}|≤|U₁+U₂|. For each Bᵢ, a crossbar design [symbol] ᵢ is constructed, which is part of a staircase structure. Unfortunately, it is not straightforward to partition the graph B into Bᵢ such that the size of Bᵢ is maximized while meeting the dimensions of crossbar Xᵢ. The partitioning makes that intermediate evaluations must be propagated to other crossbars and/or staircases. Further, only the first crossbar Xᵢ in a staircase structure is connected to the bus, which brings that the intermediate results and literals can only be fed to this first crossbar. To address these constraints, the following is proposed: a user-defined parameter defines the maximum dimensions which may be used to synthesize a bipartite graph Bᵢ. Here, it is assumed that the number of wordlines and the number of bitline-selectorline pairs is equal for a crossbar. An algorithm to construct such topology [symbol] is described below. Next, staircase intra- and inter-connections must be realized for the aforementioned constraints, as described in more detail below.

Algorithm 1 Partitioning algorithm for staircase structures

Input: B = (U₁, U₂, F), T = {T₀, ..., T_{L}}
Output: [symbol] // Set of staircase designs

| | |
|---|---|
| 1: | function TOPOLOGICALSTAIRCASEPARTITIONING(B, T) |
| 2: | i = 1, V_{i,1} = ∅, V_{i,2} = ∅, S ← ∅ |
| 3: | [symbol] ← ∅ |
| 4: | for u₂ ∈ TOPOLOGICALSORT(U₂) do |
| 5: | V′_{i,1} ← V_{i,1} ∪{u₁\|f = (u₁, u₂) ∨ f = (u₂, u₁), ∀f ∈ F} |
| 6: | V′_{i,2} ← V_{i,2} ∪ {u₂} |
| 7: | if \|V′_{i,1}\| ≤ Tᵢ Λ \|V′_{i,2}\| ≤ Tᵢ then |
| 8: | V_{i,1} ← V′_{i,1} |
| 9: | V_{i,2} ← V′_{i,2} |
| 10: | else |
| 11: | Fᵢ ← {f\|∃u₁ ∈ V_{i,1,} u₂ ∈ V_{i,2} : |
| | f = (u₁, u₂) ∨ f = (u₂, u₁), f ∈ F} |
| 12: | Bᵢ ← (V_{i,1,} V_{i,2,} Fᵢ) // Create bipartite subgraph |
| 13: | S ← S ∪ {Bᵢ} |
| 14: | i ← i + 1 |
| 15: | V_{i,1} = {u₁\|f = (u₁, u₂) ∨ f = (u₂, u₁), ∀f ∈ F} |
| 16: | V_{i,2} = {u₂} |
| 17: | if \|S\| = L then |
| 18: | [symbol] ← [symbol] ∪ {S} |
| 19: | i ← 1, S ← ∅ |
| 20: | end if |
| 21: | end if |
| 22: | end for |
| 23: | return [symbol] |
| 24: | end function |

Algorithm 1 provides the first part of the partitioning scheme. Given a bipartite graph B=(U₁, U₂, F) as input, and a user-defined threshold Tᵢ for the amount of logic that will be placed within each crossbar Xᵢ. The output of the algorithm is a topology [symbol] of staircase structures S where each S is an ordered set of crossbars Xᵢ such that Xᵢ precedes Xᵢ₊₁. The partitioning algorithm has two auxiliary variables V_{i,1} and V_{i,2} which will contain the nodes assigned to the wordlines and selectorlines, respectively. The nodes that are assigned to V_{i,1} are in U₁, and the nodes that are assigned to V_{i,2}, are in U₂.

The algorithm iterates in a topological sort over the nodes u₂∈U₂. In each iteration, node u₂ is assigned to a crossbar, together with its neighboring nodes. Recall that the nodes u₂ are the edges e∈E in the original path G=(V, E). When assigning a node u₂∈U₂ to a crossbar Xᵢ, each neighboring node u₁ is to be assigned to Xᵢ as well. This is due to that u₂ represents an edge e=(v₁, v₂)∈E between two nodes v₁, v₂∈V. Thus, one wants both its endpoints to be present in the crossbar Xᵢ.

When assigning a node u₂ to the wordlines of a crossbar V_{i,2}, one must not exceed the logic threshold Tᵢ that has been set. Similar for its neighboring nodes u₁ when assigning to the selectorlines V_{i,1} (condition of if statement on line 7). If the condition fails, a bipartite subgraph Bᵢ=(V_{i,1}, V_{i,2}, Fᵢ) (line 11-12) is created, and Bᵢ is added to the current staircase S (line 13). When the current staircase S has reached its maximum depth L (line 17), then the current staircase S is added to the topology [symbol] (line 18), and a new staircase S is created (line 19). The algorithm stops when all nodes u₂∈U₂ have been processed.

In FIG. 7A, the compressed bipartite graph B′ and the user-defined parameter T=2 are taken as input for the partitioning algorithm. In FIG. 7B, the partitioning of the bipartite graph into multiple subgraphs Bᵢ is illustrated. Each subgraph Bᵢ is delineated by a dashed line, and all its nodes have the same number i. These subgraphs are subsequently synthesized into crossbar designs Di, as previously explained, and then grouped into staircase structures.

While the algorithm partitions the bipartite graph B into bipartite subgraphs Bᵢ, which are mapped to crossbars, the hardware architecture imposes additional constraints on the design. Three staircase intra- and inter-connections have been identified that must be made to realize the crossbar mapping to a partitioning over staircase structures: edge preparation, node propagation, and literal propagation. In FIG. 7C, the crossbar design [symbol] ᵢ is taken as input. The output is a topology [symbol] of staircases by realizing the staircase intra- and inter-connections, as illustrated in FIG. 7D.

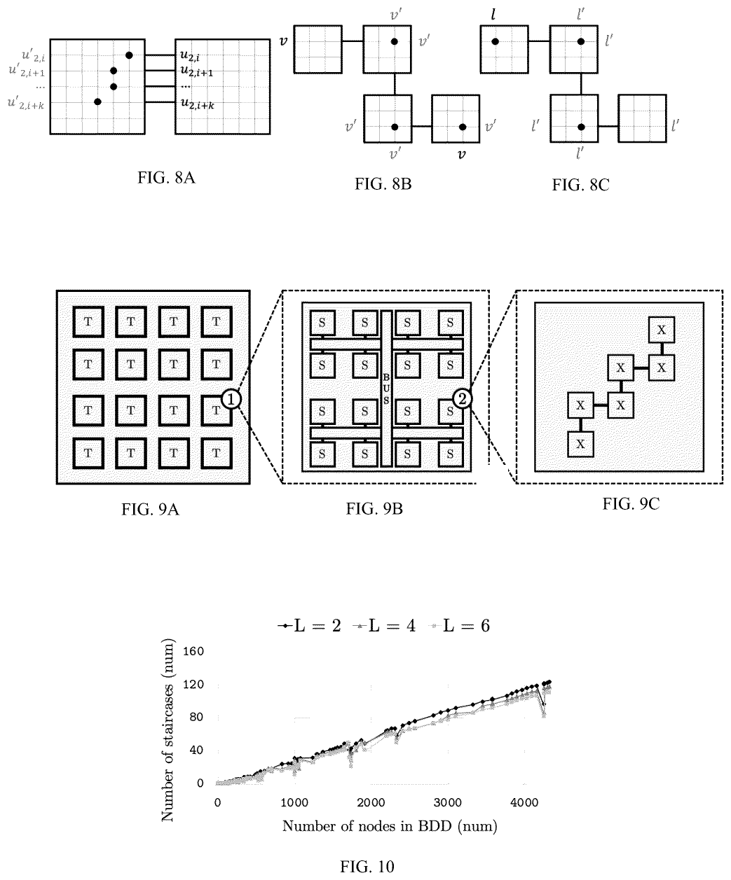

To perform edge preparation, for each crossbar Xᵢ, i>1, the selectorlines are connected to the wordlines of previous crossbar Xᵢ₋₁. In the mapping algorithm, as previously described, the nodes u₂∈U₂ are assigned to the selectorlines. This entails that the nodes must be prepared in crossbar Xᵢ₋₁. FIG. 8A is illustrates how the nodes u₂, j for crossbar X₁ are prepared in crossbar X₀.

To perform node propagation, a node u₁∈U₁ may appear in multiple crossbars Xᵢ among multiple staircases Sⱼ. From the structure of a pruned graph G, it is known that each node v∈V has at most two outgoing edges. At some point, the node will be realized, i.e., its two outgoing edges have been assigned. Let that point be denoted as Xᵣ. From this point X, forward, any other occurrence of v is to realize incoming edges of v. When v occurs at some later point in the same staircase Xᵢ, i>r, one must propagate v to that crossbar Xᵢ. This is illustrated in FIG. 8B where node v is realized in crossbar X₁ and propagated to crossbar X₄. Similarly, when v occurs in multiple staircases, then node v must be propagated from its point of realization Xᵣ to all other staircases.

To perform literal propagation, a literal l may appear in a crossbar Xᵢ, i≥2. For each such literal l, one must propagate the literal up to layer Xᵢ₋₂. For example, in FIG. 8C, the literal l appears in crossbar X₄, and is thus propagated from the first crossbar X₁ to the last crossbar X₄.

The partitioning algorithm previously presented requires a user-defined parameter T, which is a threshold for the amount of logic that will be placed in a crossbar X. As this variable is unknown in advance, a binary search over T is proposed.

Algorithm 2 Binary search over the threshold

Input: B = (U₁, U₂, F), D
Output: [symbol] // Set of staircase designs

| | |
|---|---|
| 1: | function BINARYSEARCH(T) |
| 2: | low ← ∅, high ← D |
| 3: | [symbol] ← ∅ |
| 4: | T ← └(low + high)/2┘ |
| 5: | while low ≠ high do |
| 6: | [symbol] ′ ←TOPOLOGICALSTAIRCASEPARTITIONING(B, T) |
| 7: | if [symbol] ' ≠ ∅ then // Solution found |
| 8: | [symbol] ← [symbol] ′ |
| 9: | low ← T // Increase lower bound |
| 10: | else // No solution found |
| 11: | high ← T // Decrease upper bound |
| 12: | end if |
| 13: | T ← └(low + high)/2┘ |
| 14: | end while |
| 15: | return [symbol] |
| 16: | end function |

Let all crossbars Xᵢ in a staircase structure have the same dimensions D×D. In Algorithm 2, the binary search algorithm is provided for the topological staircase partitioning. The input is the bipartite graph B=(U₁,U₂, F), and the dimensions D of the crossbars. The output is a topology [symbol] . The idea is that when for a given threshold T, no solution can be found, the threshold T is decreased. Potentially, no solution is found due to the intra- and inter-connections, as previously explained. The node propagations, literal propagations, and edge preparations may result in that a crossbar exceeds its dimensions while constructing, and consequently the partitioning algorithm fails to find a solution for the given constraints. In the other case, when for a given T, a solution can be found, this solution is retained and an attempt it made to find a better solution by increasing the threshold T.

An optimization step to improve the overall synthesis is now described. Due to the node merging optimization previously described, the node degree for all nodes u₂∈U₂ may increase. The partitioning algorithm in Algorithm 1 assigns such nodes u₂ and its neighboring nodes u₁∈U₁ to a single crossbar in a staircase. When the node degree u₂, δ(u₂), is greater than the login threshold T, such node cannot be assigned to a crossbar. A solution would be to increase the threshold T, but this brings with it that there is less room for node propagations, literal propagations, and edge preparations. Hence, there is a fine balance which must be sought between the threshold T and the node degree δ(u₂). Therefore, it is proposed to split nodes u₂∈U₂ for which δ(u₂)>T into two nodes u₂¹ and u₂².

Algorithm 3 is presented to cope with such nodes. The algorithm can be used in combination with Algorithm 2. More specifically, line 6 in Algorithm 2 can be replaced with [symbol] ←SPLITWRAPPER(B, T).

Algorithm 3 Node splitting algorithm

Input: B = (U₁, U₂, F), T
Output: [symbol] // Set of staircase designs

| | |
|---|---|
| 1: | function SPLITNODE(B, T) |
| 2: | u₂* ← argmax δ(u₂), ∀u₂ ∈ U₂ |
| 3: | if δ(u₂*) ≤ T then |
| 4: | return B |
| 5: | end if |
| 6: | X ← {u₁\|(u₁, u₂*) ∈ F} |
| 7: | Y ← {u₁\|(u₂*, u₁) ∈ F} |
| 8: | U′₁ ← U₁ |
| 9: | U′₂ ← U₂ \ {u₂*} ∪ {u₂¹, u₂²} |
| 10: | F′ ← {(u₁, u₂¹)\|u₁ ∈ X } ∪ {(u₁, u₂²)\|u₁ ∈ X} ∪ |
| | {(u₁¹, u₂¹), (u₁², u₂²)\|u₁¹ ∈ Y₁, u₁² ∈ Y₂, |
| | Y₁ ⊆ Y, Y₂ ⊆ Y, \|\|Y₁\| − \|Y₂\| ≤ 1\|} |
| 11: | B′ ← (U′₁, U′₂, F′) |
| 12: | return B′ |
| 13: | end function |
| 14: | function SPLITWRAPPER(B, T) |
| 15: | B′ ← ∅, [symbol] ← ∅ |
| 16: | while B′ ≠ B do |
| 17: | [symbol] ← TOPOLOGICALSTAIRCASEPARTITIONING(B, T) |
| 18: | if [symbol] ≠ ∅ then |
| 19: | return [symbol] |
| 20: | else |
| 21: | B′ ← SPLITNODE(B, T) |
| 22: | end if |
| 23: | end while |
| 24: | return [symbol] |
| 25: | end function |

Algorithm 3 consists of two parts: SPLITWRAPPER(B,T), and an auxiliary function SPLITNODE(B,T). The former continues to split nodes u*₂∈U₂ with maximum degree δ(u*₂) as long as a node in B is changed (line 16). The auxiliary function SPLITNODE(B,T) is used to perform this operation. On line 2, one seeks such a node u*₂∈U₂ with maximum node degree δ(u₂). When this node degree is smaller than the threshold, it is not necessary to split. Hence, the current bipartite graph B (lines 3-5) is returned. Otherwise, a new bipartite graph B′ is created where u*₂ is replaced by two new nodes u₂¹ and u₂² such that its number of edges is equal, or differs at most by one edge (lines 6-12).

Experiments are conducted on a machine with 20 Intel Core i9-9900X and 128 GB RAM. The framework is implemented in Python 3.8 and the source code is publicly available on GitHub. ABC binding for CUDD is used to construct the BDDs with dynamic variable reordering based on symmetric sifting. In Table II, an overview is provided of 10 benchmarks of the Revlib benchmark suite, eight control benchmarks from the EPFL, benchmark suite and eight ISCAS85 benchmarks. The number of inputs, outputs for each benchmark, as well as the number of nodes and edges for the respective BDD are reported.

TABLE II
Overview of ten Revlib benchmarks, eight EPFL control benchmarks,
and eight ISCAS85 benchmarks. For each benchmark, the number of
inputs and outputs is given. For their respective BDDs, the number of
nodes and edges is given.

| | Benchmark | | BDD | | Pruned | |
|---|---|---|---|---|---|---|
| | Inputs | Outputs | Nodes | Edges | Nodes | Edges |
| Benchmark | (num) | (num) | (num) | (num) | (num) | (num) |
| Revlib | | | | | | |
| in0 | 15 | 11 | 385 | 766 | 384 | 680 |
| apex2 | 39 | 3 | 567 | 1130 | 566 | 1042 |
| xpla | 16 | 46 | 594 | 1184 | 593 | 864 |
| pdc | 16 | 40 | 621 | 1238 | 620 | 887 |
| misex3 | 14 | 14 | 674 | 1344 | 673 | 1094 |
| tial | 14 | 8 | 897 | 1790 | 896 | 1717 |
| apex4 | 9 | 19 | 990 | 1976 | 989 | 1874 |
| cps | 24 | 109 | 1080 | 2156 | 1079 | 1633 |
| apex5 | 117 | 88 | 1259 | 2514 | 1258 | 2387 |
| seq | 41 | 35 | 1302 | 2600 | 1301 | 2041 |
| EPFL | | | | | | |
| arbiter | 256 | 129 | 25109 | 50214 | 25108 | 49758 |
| cavlc | 10 | 11 | 436 | 868 | 435 | 776 |
| ctrl | 7 | 26 | 89 | 174 | 88 | 128 |
| dec | 8 | 256 | 512 | 1020 | 511 | 510 |
| i2c | 147 | 142 | 1204 | 2404 | 1203 | 1936 |
| ini2float | 11 | 7 | 159 | 314 | 158 | 301 |
| priority | 128 | 8 | 772 | 1540 | 771 | 1539 |
| router | 60 | 30 | 219 | 434 | 218 | 379 |
| ISCAS85 | | | | | | |
| c432 | 36 | 7 | 1291 | 2578 | 1290 | 2463 |
| c499 | 41 | 32 | 111146 | 222164 | 111114 | 212466 |
| c880 | 60 | 26 | 5776 | 11448 | 5750 | 11151 |
| c1355 | 41 | 32 | 111146 | 222164 | 111114 | 212466 |
| c1908 | 33 | 25 | 30605 | 61110 | 30580 | 57308 |
| c2670 | 233 | 140 | 8249 | 15940 | 8109 | 14621 |
| c5315 | 178 | 123 | 15454 | 30416 | 15331 | 27477 |
| c7552 | 207 | 108 | 33983 | 67534 | 33875 | 65400 |
| Normalized | | | 1.00 | 1.00 | 1.00 | 0.85 |

The path-based computing systems is evaluated by building an architectural model. FIG. 9A-FIG. 9C illustrates the high-level architecture. The architecture consists of several tiles T on a bank, as illustrated in FIG. 9A. Each tile T has a H-tree of staircases S as topology, as shown in FIG. 9B. Four staircases with an I/O of 128 bits are connected to a Wide-I/O bus. Each staircase S is a series of crossbars X, as illustrated in FIG. 9C.

In the experimental evaluation, the performance of the proposed PATH framework is compared with COMPACT and CONTRA. The performance is compared in terms of energy, latency, and area. The parameters for the comparisons are given below. To evaluate the proposed architecture, the power consumption for the bus and the 128×128 crossbar is set to 13 mW and 0.3 mW, respectively. The design includes a 4-channel 128-bit Wide-IO bus with a rate of 400 MHz. The area for the respective components are 0.2 μm², 15.7 mm². For COMPACT, the area is extrapolated. The latency for the bus and crossbar components are 15 ns and 100 ns, respectively.

For the crossbar synthesis evaluation, no restrictions are imposed on the crossbar dimensions, such that the number of wordlines (rows), and the number of bitline-selectorline pairs (columns) can be infinitely large. The crossbar synthesis is first evaluated without and then with the proposed node merging. In Table III, the number of nodes and edges for the pruned graph G is provided, as well as the hardware resources for both approaches. For the synthesis without node merging, it is observed that the number of rows and the number of columns correspond to the number of nodes and edges of the pruned graph, respectively. This is due to the analogy between BDDs and 1T1M crossbars. Next, the number of rows and the number of columns for the approach with node merging are reported. It is observed that the number of columns (selectorline-bitlines pairs) reduces by 16% on average, resulting in an area reduction of 16% on average. From this, it is concluded that it is advantageous to work with the compressed bipartite graph B′, which will also be used throughout the following discussion. Thus, a BDD with |V| nodes and |E| edges can be synthesized into a crossbar of dimensions |V|×|E|, which is an upper bound. Empirically, it is concluded that on average a BDD with |V| nodes and |E| edges can be synthesized into a crossbar of dimensions |V|×0.84|E|.

In a first experiment, the hardware resources for varying staircase depth L, i.e., the number of crossbars in a staircase structure, are evaluated. These hardware resources are the number of staircases, the number of staircase inter-connections, and the critical path length. Table IV provides an overview of these hardware resources as well as the synthesis time for varying staircase depths L∈{1, 2, 4, 6}.

TABLE IV
Comparison of the hardware resources and synthesis time (T) for varying path-based
computing architectures. The hardware resources are expressed in terms of number of
staircases (S), number of inter-connections (I), and critical path length (C)

| | L = 1 | | | | L = 2 | | | |
|---|---|---|---|---|---|---|---|---|
| Bench- | S | I | C | T | S | I | C | T |
| mark | (num) | (num) | (num) | (min) | (num) | (num) | (num) | (min) |
| Revlib | | | | | | | | |
| in0 | 11 | 547 | 11 | 0.1 | 10 | 527 | 10 | 0.2 |
| apex2 | 16 | 767 | 16 | 0.1 | 13 | 706 | 13 | 0.2 |
| xpla | 14 | 694 | 14 | 0.2 | 12 | 666 | 12 | 0.3 |
| pdc | 14 | 645 | 14 | 0.2 | 12 | 622 | 12 | 0.2 |
| misex3 | 16 | 835 | 15 | 0.2 | 15 | 839 | 15 | 0.2 |
| tial | 27 | 1422 | 23 | 0.2 | 23 | 1404 | 21 | 0.4 |
| apex4 | 31 | 1083 | 31 | 0.2 | 27 | 1693 | 26 | 0.5 |
| cps | 27 | 1393 | 25 | 0.4 | 24 | 1388 | 23 | 0.5 |
| apex5 | 47 | 2077 | 27 | 0.4 | 36 | 2060 | 26 | 0.5 |
| seq | 37 | 1826 | 25 | 0.4 | 31 | 1823 | 27 | 0.6 |
| EPFL | | | | | | | | |
| arbiter | 889 | 49973 | 392 | 8.6 | 762 | 30348 | 314 | 12.7 |
| cavlc | 11 | 610 | 11 | 0.0 | 11 | 627 | 11 | 0.0 |
| ctrl | 1 | 0 | 1 | 0.0 | 1 | 0 | 1 | 0.0 |
| dec | 6 | 192 | 4 | 0.9 | 6 | 202 | 4 | 0.0 |
| i2c | 32 | 1616 | 25 | 0.4 | 30 | 1664 | 27 | 1.6 |
| ini2float | 4 | 146 | 4 | 0.0 | 3 | 115 | 3 | 0.0 |
| priority | 19 | 495 | 18 | 0.3 | 3.5 | 425 | 14 | 0.3 |
| router | 4 | 87 | 4 | 0.0 | 4 | 95 | 4 | 0.1 |
| ISCAS85 | | | | | | | | |
| c432 | 40 | 2121 | 40 | 0.3 | 36 | 2086 | 36 | 0.5 |
| c499 | 3592 | 160724 | 108 | 26.4 | 3212 | 163939 | 101 | 32.7 |
| c880 | 189 | 8004 | 43 | 1.5 | 167 | 7931 | 43 | 4.5 |
| c1355 | 3592 | 160724 | 108 | 26.1 | 3212 | 163939 | 101 | 32.0 |
| c1908 | 939 | 39003 | 50 | 8.7 | 835 | 39959 | 42 | 9.5 |
| c2670 | 352 | 8576 | 45 | 2.7 | 314 | 8235 | 41 | 5.1 |
| c5315 | 393 | 10699 | 25 | 3.9 | 353 | 10314 | 22 | 7.0 |
| c7552 | 1032 | 35470 | 168 | 7.7 | 894 | 34416 | 87 | 14.6 |
| Normal- | 1.00 | 1.00 | 1.00 | 1.00 | 0.89 | 0.98 | 0.92 | 1.72 |
| ized | | | | | | | | |
| | L = 4 | | | | L = 5 | | | |
| Bench- | S | I | C | T | S | I | C | T |
| mark | (num) | (num) | (num) | (min) | (num) | (num) | (num) | (min) |
| Revlib | | | | | | | | |
| in0 | 9 | 526 | 9 | 0.4 | 9 | 529 | 9 | 0.4 |
| apex2 | 11 | 630 | 11 | 0.2 | 10 | 579 | 10 | 0.4 |
| xpla | 9 | 513 | 9 | 0.2 | 7 | 430 | 7 | 0.2 |
| pdc | 9 | 526 | 9 | 0.2 | 8 | 457 | 8 | 0.2 |
| misex3 | 13 | 819 | 13 | 0.3 | 12 | 814 | 12 | 0.4 |
| tial | 21 | 1429 | 19 | 0.3 | 21 | 1414 | 19 | 0.8 |
| apex4 | 25 | 1686 | 24 | 1.0 | 23 | 1698 | 24 | 1.0 |
| cps | 20 | 1368 | 20 | 0.4 | 20 | 1364 | 20 | 0.7 |
| apex5 | 34 | 2102 | 28 | 0.9 | 33 | 2110 | 27 | 0.9 |
| seq | 28 | 1813 | 22 | 1.1 | 28 | 1831 | 27 | 0.4 |
| EPFL | | | | | | | | |
| arbiter | 717 | 50546 | 311 | 17.8 | 691 | 51035 | 307 | 15.5 |
| cavlc | 9 | 593 | 9 | 0.0 | 9 | 593 | 9 | 0.1 |
| ctrl | 1 | 0 | 1 | 0.0 | 1 | 0 | 1 | 0.0 |
| dec | 5 | 206 | 4 | 0.1 | 3 | 196 | 4 | 0.1 |
| i2c | 28 | 1639 | 25 | 0.3 | 29 | 1647 | 25 | 0.5 |
| ini2float | 3 | 106 | 3 | 0.0 | 2 | 67 | 2 | 0.0 |
| priority | 14 | 426 | 14 | 0.0 | 16 | 481 | 16 | 4.3 |
| router | 4 | 99 | 4 | 0.0 | 4 | 97 | 4 | 0.2 |
| ISCAS85 | | | | | | | | |
| c432 | 33 | 2071 | 33 | 1.6 | 32 | 2049 | 32 | 1.0 |
| c499 | 3028 | 105236 | 91 | 106.9 | 2884 | 161003 | 88 | 82.0 |
| c880 | 155 | 7730 | 42 | 4.0 | 150 | 7666 | 43 | 4.8 |
| c1355 | 3020 | 165236 | 91 | 112.1 | 2884 | 161093 | 88 | 80.4 |
| c1908 | 765 | 40000 | 42 | 31.3 | 731 | 38959 | 43 | 24.9 |
| c2670 | 295 | 7014 | 40 | 8.1 | 272 | 7199 | 41 | 11.3 |
| c5315 | 293 | 8694 | 20 | 7.8 | 277 | 7834 | 19 | 10.6 |
| c7552 | 779 | 32417 | 82 | 21.2 | 694 | 30593 | 78 | 365.2 |
| Normal- | 0.80 | 0.05 | 0.85 | 2.27 | 0.76 | 0.92 | 0.83 | 5.66 |
| ized | | | | | | | | |

It is observed that the number of required staircases decreases when the staircase depth L increases, with a reduction of 24% on average for a staircase structure of six layers compared with a single crossbar. For example, for the benchmark arbiter of the EPFL benchmark suite, the number of staircases reduces from 889 for L=1 to 961 for L=6. The number of inter-connections may increase or decrease, depending on the benchmark. For example, for arbiter, the number of inter-connections increases from 49,973 for L=1 to 51,035 for L=6. This is because the logic threshold tends to be lower for larger staircase structures, requiring more node splits, and consequently more node propagations. However, for the majority of the benchmarks (17 out of 26), the number of inter-crossbar connections decreases, with a reduction of 8% on average for six layers compared with a single crossbar. For example, for benchmark cavlc of the Revlib benchmark suite, the number of staircase inter-connections decreases from 610 for L=1 to 566 for L=6. Finally, it is observed that the critical path length reduces by 17% on average for L=6 compared with L=1. The reduction of the number of staircases brings with it that the critical path length decreases. This is because the critical path length is at most the number of staircases, and the number of staircases for L=6 is lower than the number of staircases for L=1. From these results, one can conclude it is best to utilize a path-based computing system with larger staircase structures.

Next, an analysis of the hardware utilization in terms of the intermediate data structure is made. More specifically, in FIG. 10, the number of required staircases in terms of the number of BDD nodes is shown for different staircase depths. The crossbar dimensions are 128×128, and the BDDs are collected from the eight ISCAS85 benchmarks. From this figure, one can clearly observe there is a linear trend between these two dimensions. Further, it can be observed at first glance that the number of required staircases decreases for increasing staircase depth (the line for L=2 lies higher than for L=4, and L=4 lies higher than for L=6). This corresponds with the results in Table IV. For L=2, L=4, and L=6, the trendline is described by the following equations, respectively: 0.0285x−0.0126, 0.0268x−0.02782, and 0.0255x−0.3139 where x is the number of BDD nodes.

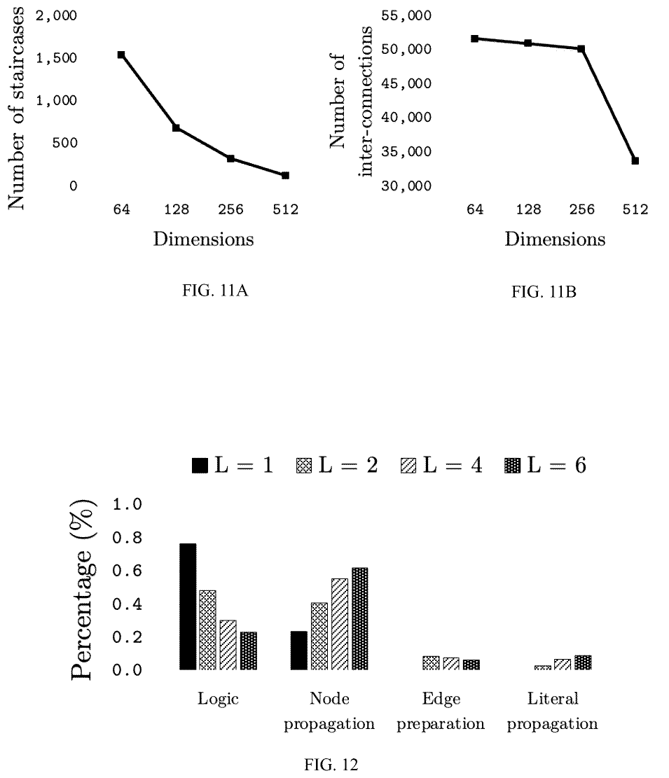

The PATH framework in terms of the crossbar dimensions is now evaluated on the benchmark arbiter using a staircase depth of six crossbars. In FIG. 11A, it is shown that the trendline for the number of staircases is a function of the crossbar dimensions. It is observed that for increasing crossbar dimensions, the number of staircases decreases. This is expected as there is more room in a crossbar for both logic and node propagations. In FIG. 11B, it can be observed that the number of inter-connections decreases as the crossbar dimensions increase. This is also expected as more logic can be realized within a single staircase, and thus less inter-staircase communication is required.

The fact that the partitioning method requires some intra- and inter-connections in order to be a functional computing paradigm has been previously described. An analysis of the components that constitute the overall synthesis using partitioning is now discussed. These components are logic, edge preparation, node propagation, and literal propagation. This analysis may give further insight into the synthesis method with the objective of improving any future work on the currently proposed framework.

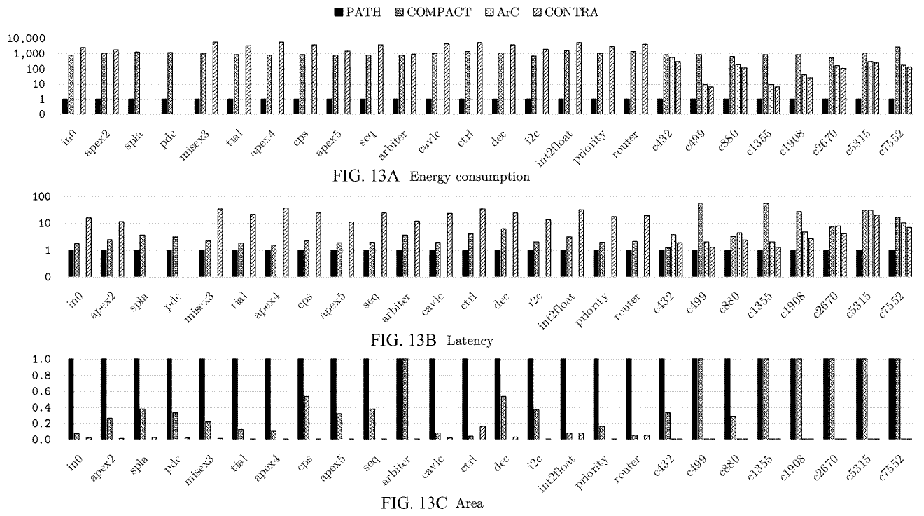

FIG. 12 illustrates the percentages for each of the components for a varying number of layers L where L∈{1, 2, 4, 6}. It is observed that the percentage of logic, which is defined by the threshold T, decreases for increasing number of layers L. This is due to that the number of node propagations increases when the number of layers L increases, which can also be seen in FIG. 12. As previously discussed, there is a find balance between the threshold T and the node degree δ(u₂). When the node degree decreases, the number of node propagations increase, and vice versa.

The path-based computing paradigm (PATH) of the present invention is now compared with other digital in-memory computing paradigms known in the art. More specifically, the present paradigm is compared with COMPACT, ArC, and CONTRA. COMPACT is the state-of-the-art synthesis method for flow-based computing. ArC for MAJORITY, and CONTRA is the state-of-the-art MAGIC-based general purpose synthesis method. No comparison is provided with IMPLY-based logic, because recent papers have shown that IMPLY-based logic is inferior to MAGIC-based logic.

In FIG. 13A-FIG. 13C, a detailed comparison is given for the normalized energy consumption (FIG. 13A), latency (FIG. 13B), and area (FIG. 13C) for all benchmarks (except spla and pdc as CONTRA failed to generate a result) using PATH, COMPACT, and CONTRA. For ArC, only the ISCAS85 benchmarks are reported based on known results. Note that the latency only reflects the execution time, i.e., the runtime to evaluate Boolean functions, and does not include the synthesis time as reported in Table IV nor the crossbar programming. Compared with PATH, COMPACT requires approximately 1006× more energy, and has approximately 10× longer latency on average. The advantageous performance mainly stems from the fact that COMPACT is a flow-based computing framework where the devices are continuously switched for each evaluation, resulting in many expensive (in terms of energy and latency) WRITE operations. No partitioning scheme exists for COMPACT, so the crossbar size of a 128×128 crossbar was extrapolated to the required dimensions. For COMPACT, some benchmarks require more area than PATH, so they plot unity has been truncated for clarity (e.g., arbiter has 4× area). On average, COMPACT requires 5.8× of the area of PATH. Further, it can be observed that CONTRA consumes approximately 2166× more energy and is approximately 15× slower than PATH on average. Similarly to previous argument, CONTRA is much less energy-efficient and slower than PATH due to the large number of write operations. The path-based paradigm only utilizes WRITE operations in the compilation phase, which is amortized across many function evaluations. On average, CONTRA requires only 2% of the area of PATH. Lastly, ArC requires on average 175.96× more energy than PATH and is 8.30× slower than PATH due to the many WRITE operations.

In various embodiments, the present invention provides a new READ-based in-memory computing paradigm, called path-based computing, by leveraging access transistors to perform logic. A framework, called PATH, has been introduced to automatically synthesize Boolean circuits to path-based computing systems. The PATH framework relies on an analogy between bipartite graphs and 1T1M crossbars. The bipartite graphs are derived from BDDs, and serve as an intermediate data representation. Further, an optimization technique has been introduced wherein these bipartite graphs are compressed, resulting in an area reduction of 16%. Finally, a partitioning algorithm has been introduced to map Boolean functions to a topology of staircase structures, where a staircase structure is an ordered set of crossbars, which have hardwired connections between them. By introducing staircases, the bus utilization diminishes, which results in high energy and latency improvements. The experimental results demonstrate that the paradigm is orders of magnitude faster than state-of-the-art in-memory computing paradigms with energy improvements of 1006×, on average. The latency improvements are 10× on average. It is envisioned that leveraging alternative intermediate data structures may improve the overall synthesis method. Further, alternative or orthogonal approaches to the proposed partitioning algorithm are an interesting trajectory for further research.

The present invention may be embodied on various computing platforms that perform actions responsive to software-based instructions and most particularly on touchscreen portable devices. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. However, as indicated above, due to circuit statutory subject matter restrictions, claims to this invention as a software product are those embodied in a non-transitory software medium such as a computer hard drive, flash-RAM, optical disk or the like.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object-oriented programming language such as Java, C#, C++, Visual Basic or the like and conventional procedural programming languages, such as the “C” programming language or similar programming languages.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A method for evaluating Boolean functions using in-memory computing, the method comprising:
receiving one or more Boolean functions as input to a compilation phase;
synthesizing a crossbar design during the compilation phase for the one or more Boolean functions, wherein the crossbar design comprises a plurality of non-volatile memory devices;
programming each of the plurality of non-volatile memory devices in the crossbar design to a resistive state; and
performing an evaluation phase for a given Boolean function with the programmed non-volatile memory devices, wherein the evaluation phase comprises only READ operations.

2. The method of claim 1, wherein synthesizing the crossbar design for the one or more Boolean functions during the compilation phase further comprises:
deriving a binary decision diagram (BDD) from the one or more Boolean functions;
performing graph pre-processing and graph transformation of the BDD to generate a bipartite graph comprising a plurality of nodes;
performing graph compression of the bipartite graph to generate a compressed bipartite graph; and
performing crossbar realization of the compressed bipartite graph to synthesize the crossbar design.

3. The method of claim 2, wherein the bipartite graph comprises a plurality of nodes and wherein performing graph compression of the bipartite graph to generate the compressed bipartite graph further comprises merging one or more nodes of the bipartite graph.

4. The method of claim 2, wherein performing crossbar realization of the compressed bipartite graph to synthesize the crossbar design for the one or more Boolean functions further comprises exploiting an analogy between BDDs and a one-transistor one-memristor (1T1M) crossbar design to map the compressed bipartite graph to the crossbar design.

5. The method of claim 4, wherein the 1T1M crossbar design comprises a plurality of wordlines, a plurality of bitlines and a plurality of selectorlines, wherein each of the plurality of wordlines is connected to each of the plurality of bitlines using a series-connected memristor and access transistor and wherein vertically aligned access transistors share a single selectorline of the plurality of selectorlines.

6. The method of claim 4, wherein the 1T1M crossbar design specifies a state of each of the plurality of non-volatile memory devices, a Boolean variable assigned to each of a plurality of bitline-selectorlines, and an input and output assigned to each of a plurality of wordlines.

7. The method of claim 2, wherein synthesizing the crossbar design further comprises constructing a topology of staircase structures in the crossbar design.

8. The method of claim 7, wherein the topology of staircase structures is an ordered set of crossbars in the crossbar design having hardwired intra-connections and inter-connections.

9. The method of claim 7, wherein constructing the topology of staircase structures in the crossbar design further comprises:
partitioning the compressed bipartite graph into a plurality of subgraph;
given a user-defined threshold parameter for an amount of logic to be placed in a crossbar of the crossbar design, mapping each of the plurality of subgraphs into a crossbar of the crossbar design; and
constructing the topology of staircase structures by realizing the intra-connections and inter-connections of the crossbar design.

10. The method of claim 1, wherein programming the plurality of non-volatile memory devices in the crossbar design to a resistive state further comprises:
programming each of the plurality of non-volatile memory devices as ON or OFF by applying a voltage with an appropriate polarity and magnitude; and
utilizing a write-and-verify scheme to ensure that the plurality of non-volatile memory devices have been programmed correctly.

11. The method of claim 4, wherein ON is a low-resistance state (LRS) and OFF is a high-resistance state (HRS).

12. The method of claim 1, wherein the crossbar design comprises a plurality of wordlines, a plurality of bitlines and a plurality of selectorlines, wherein each of the plurality of wordlines is connected to each of the plurality of bitlines using a series-connected memristor and access transistor and wherein vertically aligned access transistors share a single selectorline of the plurality of selectorlines, and wherein performing the evaluation phase for a given Boolean function comprises:
providing an instance of Boolean variables to the plurality of selectorlines;
applying an input voltage to a top-most wordline of the plurality of wordlines; and
measuring an output voltage across a resistor coupled to a bottom-most wordline.

13. The method of claim 12, wherein if the output voltage across the resistor is HIGH, the given Boolean function evaluates to TRUE, otherwise, the given Boolean function evaluates to FALSE.

14. A system for evaluating Boolean functions using in-memory computing, the system comprising:
a plurality of non-volatile memory devices synthesized into a cross bar design; and
WRITE circuitry coupled to the plurality of non-volatile memory devices, wherein the plurality of non-volatile memory devices are programmed by the WRITE circuitry to a resistive state during a compilation phase based upon one or more Boolean functions; and
READ circuitry coupled to the plurality of non-volatile memory devices, wherein the READ circuitry performs only READ operations on the plurality of non-volatile memory devices during an evaluation phase to evaluate a given Boolean function.

15. The device of claim 14, wherein the crossbar design comprises a plurality of wordlines, a plurality of bitlines and a plurality of selectorlines, wherein each of the plurality of wordlines is connected to each of the plurality of bitlines using a series-connected memristor and access transistor and wherein vertically aligned access transistors share a single selectorline of the plurality of selectorlines.

16. The device of claim 14, wherein the crossbar design further comprises a topology of staircase structures.

17. The device of claim 16, wherein the topology of staircase structures is an ordered set of crossbars in the crossbar design having hardwired intra-connections and inter-connections.

18. A non-transitory computer-readable medium, the computer-readable medium having computer-readable instructions stored thereon that, when executed by a computing device processor, cause the computing device to:
receiving one or more Boolean functions as input to a compilation phase;
synthesizing a crossbar design during the compilation phase for the one or more Boolean functions, wherein the crossbar design comprises a plurality of non-volatile memory devices;
programming each of the plurality of non-volatile memory devices in the crossbar design to a resistive state; and
performing an evaluation phase for a given Boolean function with the programmed non-volatile memory devices, wherein the evaluation phase comprises only READ operations.

19. The non-transitory computer-readable medium of claim 18, wherein the crossbar design comprises a plurality of wordlines, a plurality of bitlines and a plurality of selectorlines, wherein each of the plurality of wordlines is connected to each of the plurality of bitlines using a series-connected memristor and access transistor and wherein vertically aligned access transistors share a single selectorline of the plurality of selectorlines.

20. The non-transitory computer-readable medium of claim 18, wherein the crossbar design further comprises a topology of staircase structures, wherein the topology of staircase structures is an ordered set of crossbars in the crossbar design having hardwired intra-connections and inter-connections.
